(19) United States
(12) Patent Application Publication
(10) Pub. No.: US 2011/0007919 A1
(43) Pub. Date: Jan. 13, 2011

(54) LOCKING MECHANISM FOR ADJUSTABLE TUBE

(75) Inventors: Paul C. Aquilina, Kitchener (CA); Li Li, Mississauga (CA)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/922,703

(22) PCT Filed: Mar. 17, 2008
(86) PCT No.: PCT/EP2008/053176

§ 371 Date: Sep. 15, 2010

(51) Int. Cl. H04R 25/00

(52) U.S. Cl. 381/324

(57) ABSTRACT

An in the ear hearing aid component, acoustically connected to a hearing aid component outside the ear canal, is characterized by adjusting means (3) in length of the connecting means (3) within at least one of the hearing aid components.

The present invention refers to an in the-ear-hearing aid component according the preamble of claim 1 and to a process for adjusting the length of a tube like connecting element of hearing aid components.

Variations in the physicality of human beings has resulted in countless combinations of length, width and height of human beings, all with a corresponding result in body shape and mass. Specifically focusing on the basic theme of “size”, these variations also hold true when it comes to the physical dimensions, and geometry, of the human ear. To the placement of hearing aid components at a human ear and interconnecting the various components as microphones, receivers, loud speakers, bodies of hearing aids, etc., the individual geometry of human beings and in particular of the human ear, has to be taken into consideration.

To accommodate this variation for thin tube for the interconnection of hearing aid components such as external receivers, microphones and the like, the hearing aid industry has adopted a general system e.g. that employs distinct tube sizes, the length of tubes, etc. for interconnecting the various components. A particular size corresponds to the vertical distance taken from the top of the pinna/skull intersection, to the centre of the ear canal.

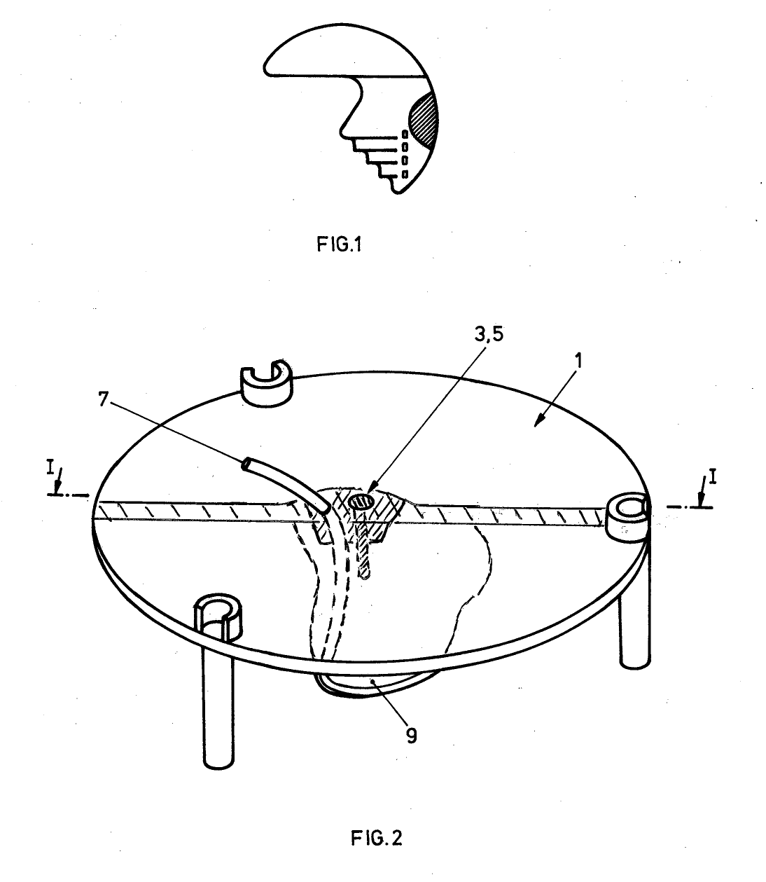

To establish the size e.g., a measuring tool known as a “thin tube gauge” as shown in FIG. 1 of the present invention document is proposed.

In practice an audiologist places the gauge over the pinna/skull intersection, holding it in position against the patient's head. Using the centreline of the patient's ear canal as the lower reference point, the patient's size labelled 0 to 3 as indicated within the measuring instrument as shown in FIG. 1, can be read off from the gauge. Size “0” is the shortest, while size “3” is the longest.

Of note is that the variation in physicality will result in a preponderance of measurements falling “in-between” the four distinct sizes as identified by the measuring tool as shown in FIG. 1.

An in-between size measurement will necessitate the audiologist to estimate a closest best fit for the patient, one that lies the closest to one of the 4 available size fittings.

It is quite obvious that such a kind of measurement can never take the situation in practice into consideration and furthermore, at movements of a patient, the length of a tube can be either too long or too short, which will cause uncomfortable feelings for the patient.

It is therefore an object of the present invention to simplify the interconnection of various hearing aid components and the adjustment in case of change of the location of the components. More particularly it is an object of the present invention to address the requirement of providing an adjustment mechanism which enables the audiologist to perfectly adjust the size and orientation of, e.g., a thin tube flexible connector that couples a behind-the-ear hearing aid component to an in-the-ear hearing aid component such as a receiver on the patient's ear so that the system becomes a custom fitting.

As a result, the present invention proposes an in-the-ear hearing aid component connected to a hearing aid component outside the ear canal comprising at least one lockable adjusting means for e.g. the length or the angle of the connecting means which is arranged within at least one of the hearing aid components.

The adjustable means may comprise a longitudinal and/or angular locking mechanism for permitting to adjust e.g. the length of the connecting means such as a thin tube, a wire or the like within at least one of the hearing aid components, preferably within the in-the-ear hearing aid components comprising, e.g., a receiver or loudspeaker respectively.

A locking insert is provided to again releasable fix on one end of the connecting thin tube, wire or the like within a curved tunnel section, provided within the at least one hearing aid component, such as the in-the-ear component.

The curved tunnel is shaped so that it is abutting to the locking mechanism or it is at least partially formed within the locking mechanism which may be an insert piece to be placed within a respective cavity within the hearing aid component body. The locking insert piece can be releasable fixed by means of a locking screw for fixing the insert within the hearing aid component body.

Further specific designs of the fixing or locking means, according the present invention, are characterized within dependent claims and further described with reference to the attached figures.

For adjusting the length of a connecting tube like element for the interconnection of hearing aid components the at least one hearing aid component can be placed within a so called faceplate, comprising a central cavity and a general curved tubular canal cavity within the hearing aid component body next to the cavity or between the faceplate and the locking insert piece, provided for being inserted into the central cavity.

The connecting tube which means the thin tube is inserted into the curved tubular tunnel by forcing the flexible plastic tube to follow the general profile of the curved tunnel section. The ribs may be arranged longitudinally along the tunnel as well as per pendiculary, saw tooth shaped e.g. located protruding from the longitudinally or vertical ribs. But the ribs could also be arranged in diagonal direction.

After the thin tube has been inserted within the curved tunnel, taking the correct length into consideration, the locking insert component is inserted into the central cavity and is tightened, e.g. by tightening a locking screw into the faceplate—the thin tube is forced closer to the profile of the tunnel.

The described process and the locking mechanism is reversible as upon loosening of the locking screw pressure is taken from the elastic thin tube and the locking insert mechanism is repositioned away from the faceplate. At this point, the curved tube shape will regain a more relaxed and straighter profile.

The adjustment of the thin tube is both of a radial and a vertically in or out vector as reference against the faceplate.

By arranging ribs within the curved tunnel and even more secure fastening of the thin tube within the curved tunnel is possible. A retightening of the locking screw will relock the tube position whereby the internally provided ribs as proposed above the flexible tube is deformed once again into the curved profile.

Upon loosening of the locking screw the thin tube will naturally attempt to revert back to its original straight extruded profile.

The invention shall be described in more details and with reference to the attached figures.

FIG. 1 shows a measuring tool as actually used to determine the length for an interconnecting tube between various hearing aid components,

FIG. 2 shows an adjustable thin tube system according the present invention for hearing aid components with a locking mechanism,

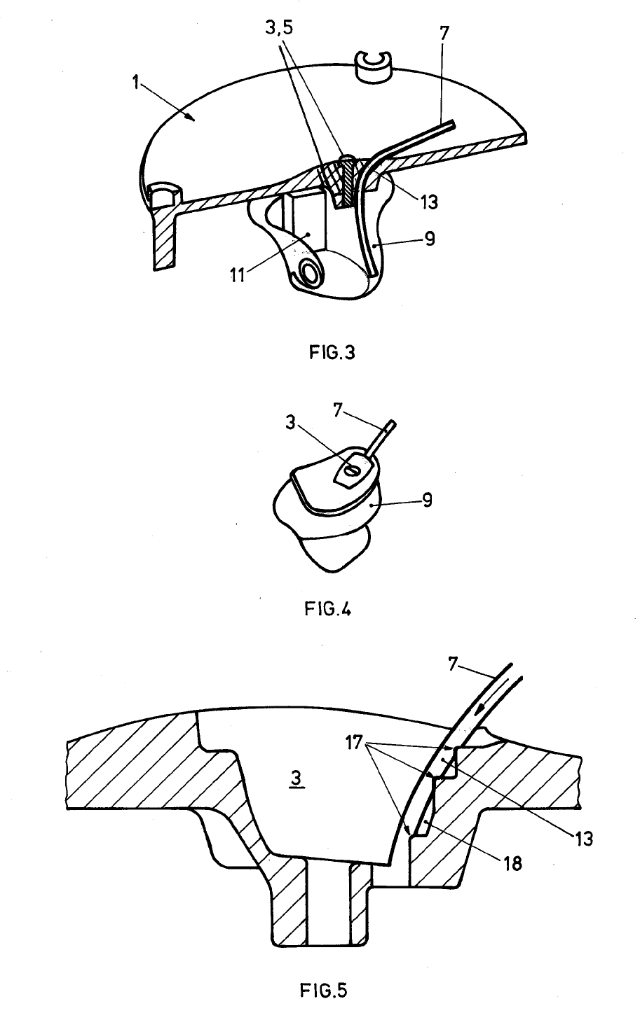

FIG. 3 shows a sectional view of FIG. 1 along the line I-I,

FIG. 4 shows an in-the-ear hearing aid component comprising a locking mechanism for the adjustment of the connecting tube,

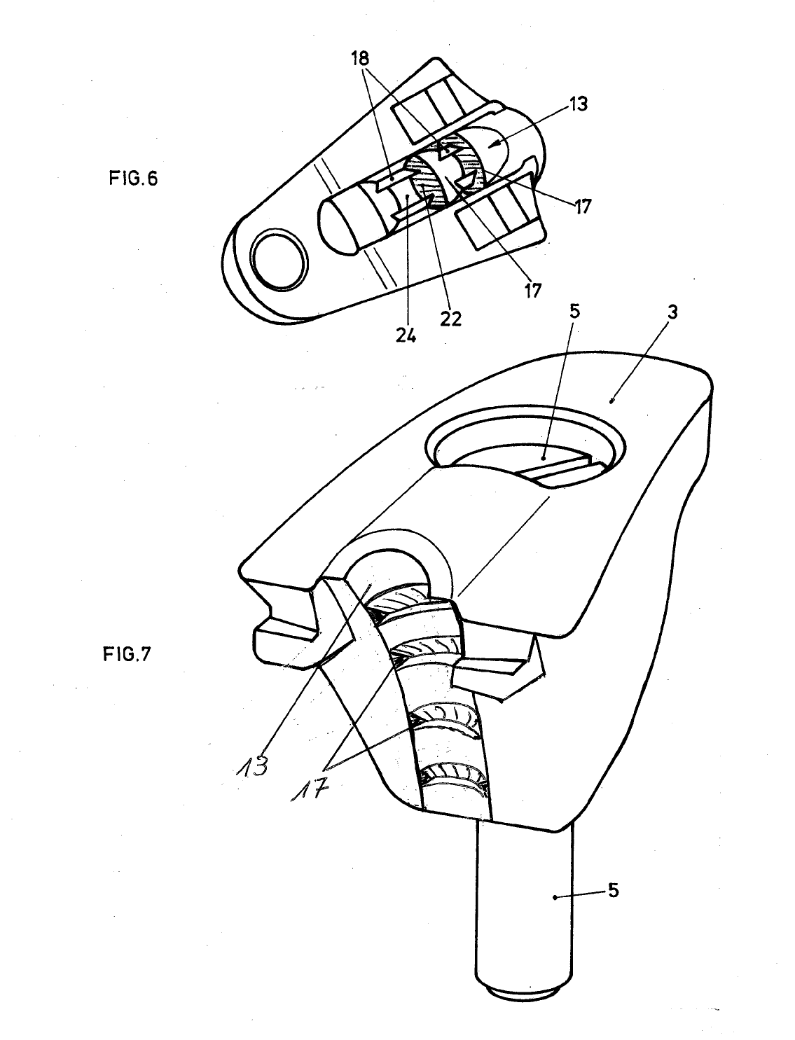

FIG. 5 shows a sectional view through the locking mechanism and the curved tunnel section for receiving a connecting tube, and

FIG. 6 shows a schematic plan view onto the interior tunnel surface of the tunnel in FIG. 5 showing the vertical and horizontal ribs, and

FIG. 7 shows in perspective view a locking insert with locking screw.

FIG. 1 shows a measuring tool as described at the beginning of the description of the present invention. This measuring tool, also called “thin tube gauge” is inaccurate and leads to problems by determining the length of connecting tubes between various hearing aid components such as, e.g., a behind-the-ear hearing aid and an insert into the ear canal comprising a receiver element.

FIG. 2 shows an adjustable thin tube system for hearing aids with a locking mechanism according the present invention. At a transparent faceplate component 1, which is shown untrimmed at the centre of a locking insert 3 is provided, which is tightened by means, e.g., of a metal tightening screw 5. By means of the locking insert a slim tube 7, which is shown, cut off, is held within a hearing aid component 9, which is hardly visible arranged at the faceplate component 1. For better understanding FIG. 3 shows a sectional view along the line I-I, in which figure the hearing aid component 9 comprising e.g., a receiver element 11 is visible. The slim tube 7 is inserted within a curved tunnel section 13, which is provided between the faceplate component 1 and the locking insert component 3.

FIG. 4 shows the hearing aid component 9 released from the faceplate component 1 in which the slim connecting tube 7 is held by means of the locking insert 3. The thin tube 7 is connecting the hearing aid component 9 with e.g., a behind-the-ear hearing aid, which is located at the pinna of the human's ear.

FIG. 5 again shows the sectional view through the middle of the hearing aid component where the thin connecting tube 7 is held by means of the locking insert 3. The tube 7 is held within a circular tunnel section 13; further comprising horizontal ribs 17 and 2 vertical or longitudinal ribs 18 to secure the tube against slipping out of the tunnel section 13. The 3 shown horizontal ribs 17 are saw tooth shaped and are protruding or lying above the two longitudinal ribs 18, as better seen in the plain view as shown in FIG. 6. FIG. 6 shows a plan view onto the interior surface of the tunnel section 13, whereas the tunnel surface side of the insert 3 is removed.

As shown in FIGS. 5 and 6 the horizontal or triangular ribs 17 create depressions 22, provided to be positioned on the underside of a slim tube and the longitudinal or vertical ribs 18 create depression valleys 24 lying in between the longitudinal ribs. By arranging vertical and horizontal ribs a substantial improvement in retention of the slim tube can be achieved which is a result of a serpentine like curve of the slim tube within the various valleys and depressions.

FIG. 7 finally shows in perspective view the locking insert 3 comprising the tightening screw 5. Within a sidewall of the locking insert 3 part of the tunnel section 13 is provided further comprising ribs 17 for fixing the tube within the tunnel.

The locking mechanism as shown with reference to FIGS. 2 to 6 is of course only one example, which can be modified and/or combined with further elements. The insert is described with reference to a hearing aid component designed for being arranged within an ear canal of a human's ear. But of course the locking mechanism could also be arranged at a hearing aid component outside the ear canal, which means e.g., at a BTE hearing aid component. Furthermore, the insert could also be held within the hearing aid component by other fixing means instead of the described screw. E.g., a snap mechanism could be arranged or another suitable fixing mechanism.

Furthermore, the described fixing mechanism could also be used to hold any different kind of connecting means such as, e.g., a connecting wire. Important is, that the connecting means, as e.g. the described thin connecting tube is adjustable in respect to its length, so that upon e.g. uncomfortable feelings of a person wearing a hearing aid device, the length is adjustable at any time.

The benefit of the adjustable connecting tube system in respect to its length is that opposite to the means as used in the art any tube length can be sized and adjusted for connecting various hearing aid components at an ear of a wearing person. The result is that costs can be reduced when adapting a hearing aid device at the ear of a person who is wearing the hearing aid. Furthermore, irritations to the user's ear anatomical sections that previously resulted from forces acting against the restraint—that being the ear canal—will be reduced or eliminated since the present invention allows a thorough custom fit to the individuals anatomy. Consumer complaints will decrease while satisfaction will rise because each user can now be exactly custom fitted with a specific fitting measuring and designed technology that perfectly match to the respective anatomy.

1. In the ear hearing aid component connected to a hearing aid component outside the ear canal characterized by a lockable adjusting means (3) of connecting means (7), the adjusting means being arranged within at least one of the hearing aid components.

2. Hearing aid component characterized in, that the adjustment means comprising a longitudinal and/or angular locking mechanism (3, 5) for permitting to adjust e.g. the length and/or the angle of the connecting means (7) such as a tube or a wire within at least one of the hearing aid components (9).

3. Hearing aid component according to one of the claims 1 or 2 characterized in that a locking insert (3) is provided for releasable fix on one end of the connecting means such as a tube (7) or a wire within a curved tunnel section (13) provided within the at least one hearing aid components (9).

4. Hearing aid component according claim 3 characterized in that the curved tunnel is shaped such that it is abutting to the locking mechanism or is at least partially formed within the locking mechanism such as the locking insert.

5. Hearing aid component according to one of the claims 1 to 4 characterized in that the adjustable means or locking insert is releasable arranged within a respective cavity of the hearing aid component body, preferably fixed by a tightening screw (5).

6. Hearing aid component according to one of the claims 3 to 5 characterized in, that within the curved tunnel section (13) retaining means such as ribs (17,18) are arranged to hold the connecting means such as a thin tube in position.

7. Hearing aid component according to one of the claims 3 to 6 characterized in that within the curved tunnel section (13) vertical which means longitudinally extending ribs (18) as well as horizontal, which means transverse extending ribs (17) are arranged to hold the connecting means such as a thin tube in position.

8. Hearing aid component according to one of the claims 1 to 7 characterized in, that the adjustable means or the locking insert is arranged within the in-the-ear hearing aid component further comprising at least one receiver (11).

9. Process for adjustable arranging a connecting means between at least two hearing aid components, one of the components being an in-the-ear hearing aid component characterized in, that within at least one of the components an adjustable means is arranged such, that the connecting means such as a thin tube is inserted into a tunnel like section in its appropriate length and is fixed in position by inserting the adjustable means or an insert respectively into a respective cavity of the hearing aid component body.
